(19) United States
(12) Patent Application Publication
(10) Pub. No.: US 2011/0043127 A1
(43) Pub. Date: Feb. 24, 2011

(54) LED ASSEMBLY AND CIRCUIT FOR USE IN FLUORESCENT LAMP FIXTURES

(76) Inventor: Shigeaki Yamasaki, Ibaraki (JP)

Correspondence Address: WADDEY & PATTERSON, P.C., 1600 DIVISION STREET, SUITE 500, NASHVILLE, TN, 37203, US

(21) Appl. No.: 12/860,586

(22) Filed: Aug. 20, 2010

(30) Foreign Application Priority Data
Aug. 20, 2009 (JP) 2009-191277

(51) Int. Cl. H05B 37/02

(52) U.S. Cl. 315/291

(57) ABSTRACT

An LED assembly has an AC voltage applied from a fluorescent lamp fixture via one or more power supply connectors belonging to a base which can be attached to the fluorescent lamp fixture, and the LED assembly includes a resistive circuit having impedance equivalent to that of a filament of a fluorescent lamp which can be attached to the fluorescent lamp fixture, a rectifier circuit for rectifying an AC voltage supplied via the resistive circuit, and a load circuit to be operated in response to a supply of a voltage rectified by the rectifier circuit.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application which is hereby incorporated by reference: Japan Patent Application No. 2009-191277, filed Aug. 20, 2009.

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates to an LED assembly and driver circuit which can be attached to existing fluorescent lamp fixtures.

LED (light-emitting diode) lamps have been proposed, in place of existing incandescent lamps and fluorescent lamps, to reduce the amount of power consumption and realize a longer lamp life. In a conventional example of such an LED lamp, an AC input terminal of a bridge rectifier is connected to a base which is to be mounted to a lamp socket of an existing fluorescent lamp fixture. A group of a required number of serially connected LEDs and a capacitor having a required electrostatic capacitance are connected in parallel between the AC input terminal and a DC output terminal of the bridge rectifier.

Each base is mounted on a lamp socket of an existing fluorescent lamp fixture from which a lamp tube was previously removed. An AC current input from terminals is converted into a DC current by the bridge rectifier and smoothed by the capacitor, after which it is supplied to turn on and drive each of the LEDs. This conventional LED lamp as described can be thus attached and used in place of an existing fluorescent lamp by simply removing the lamp tube from an existing fluorescent lamp fixture and without applying any modifications to the existing fixture.

However, if the above described LED lamp is attached to, for example, an existing fluorescent lamp fixture having a conventional rapid-start system 500 as shown in FIG. 12, the preheat winding in ballast 502 as shown by a dotted line in FIG. 12 will become short-circuited. Further, even if the above described LED lamp is attached to an existing fluorescent lamp fixture having an inverter ballast system 504 as shown in FIG. 13, a line in the inverter (or ballast) 506 will also become short-circuited.

Certain LED lamp assemblies 508, 510, 512 for a fluorescent lamp fixture as currently on the market include partially modified wiring between an AC power source (AC) and bases 514a, 514b arranged on both sides of an LED lamp (LED) as shown in FIGS. 14 to 16, respectively. However, if an LED lamp as described above is attached to, for example, the LED lamp lighting apparatus 512 for a fluorescent lamp type with wiring as shown in FIG. 16, the AC power source will likely be short-circuited and creating a problem in operational safety.

### BRIEF SUMMARY OF THE INVENTION

An LED lamp assembly is provided in various embodiments within the general scope of the present invention, which can be used to realize safe lamp and fixture operation without causing a short-circuit in a power source, even if it is attached to a fluorescent lamp fixture with modified wiring, and irrespective of the type of fluorescent lamp fixture.

One example of an LED assembly of the present invention is supplied with an AC voltage from a fluorescent lamp fixture via a power supply connector within a base which can be attached to the fluorescent lamp fixture. The LED assembly includes a resistive circuit having an impedance equivalent to that of a filament of a fluorescent lamp which can be attached to the fluorescent lamp fixture, a rectifier circuit for rectifying an AC voltage supplied via the resistive circuit, and a load circuit to be operated in response to a rectified voltage input from the rectifier circuit.

The combined impedance in the resistive circuit and the load circuit in an LED assembly of the present invention may also be equivalent to that of impedance obtained in lighting of a fluorescent lamp.

An LED assembly of the present invention may be provided with a filter circuit between the power supply connector and the resistive circuit to remove noise from the AC voltage.

Bases may be provided at both ends of an LED assembly of the present invention, wherein in certain embodiments the filter circuit includes a first filter circuit arranged between a first resistive circuit for receiving AC voltage via one of the bases, and a second filter circuit arranged between a second resistive circuit for receiving AC voltage via the opposing base.

The load circuit in an LED assembly of the present invention may include an AC/DC converter. In various embodiments the load circuit may also include a distortion suppressing circuit for suppressing distortion of current input or power factor correction from the rectifier circuit.

The load circuit in an LED assembly of the present invention may be a light source, and the light source in an embodiment may be an LED unit.

The load circuit in an LED assembly of the present invention may alternatively be a sensor.

### BRIEF DESCRIPTION OF THE SEVERAL VIEWS OF THE DRAWINGS

FIG. 1 is a circuit diagram showing an internal configuration of an LED assembly according to an embodiment of the present invention.

FIG. 2 is a circuit diagram showing an internal configuration of an LED unit according to an embodiment of the present invention.

FIG. 3 is a circuit diagram showing an internal configuration of an LED unit according to another embodiment of the present invention.

FIG. 4 is a circuit diagram showing an internal configuration of an LED unit according to another embodiment of the present invention.

FIG. 5 is a circuit diagram showing an internal configuration of an LED unit according to another embodiment of the present invention.

FIG. 6 is a circuit diagram showing an internal configuration of an LED unit according to another embodiment of the present invention.

FIG. 7 is a circuit diagram showing another embodiment of an internal configuration of an LED assembly according to the present invention.

FIG. 8 is a circuit diagram showing another embodiment of an internal configuration of an LED assembly according to the present invention.

FIG. 9 is a circuit diagram showing another embodiment of an internal configuration of an LED assembly according to the present invention.

FIG. 10 is a circuit diagram showing a modified example of the LED assembly according to the embodiment of FIG. 9.

FIG. 11 is a circuit diagram showing another embodiment of an internal configuration of an LED assembly according to the present invention.

FIG. 12 is a simplified circuit diagram showing a conventional fluorescent lamp fixture of a rapid-start system.

FIG. 13 is a simplified circuit diagram showing a conventional fluorescent lamp fixture of an inverter-type system.

FIG. 14 is a simplified wiring diagram showing an example of a connection between an AC power source and bases as required in a conventional LED assembly adapted for a fluorescent lamp fixture.

FIG. 15 is a simplified wiring diagram showing another example of a connection between an AC power source and bases as required in a conventional LED assembly adapted for a fluorescent lamp fixture.

FIG. 16 is a simplified wiring diagram showing another example of a connection between the AC power source and the bases as required in a conventional LED assembly adapted for a fluorescent lamp fixture.

### DETAILED DESCRIPTION OF THE INVENTION

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” may include plural references, and the meaning of “in” may include “in” and “on.” The phrase “in an embodiment,” as used herein does not necessarily refer to the same embodiment, although it may.

Various embodiments of an LED assembly in accordance with the present invention may now be described with reference to the accompanying drawings.

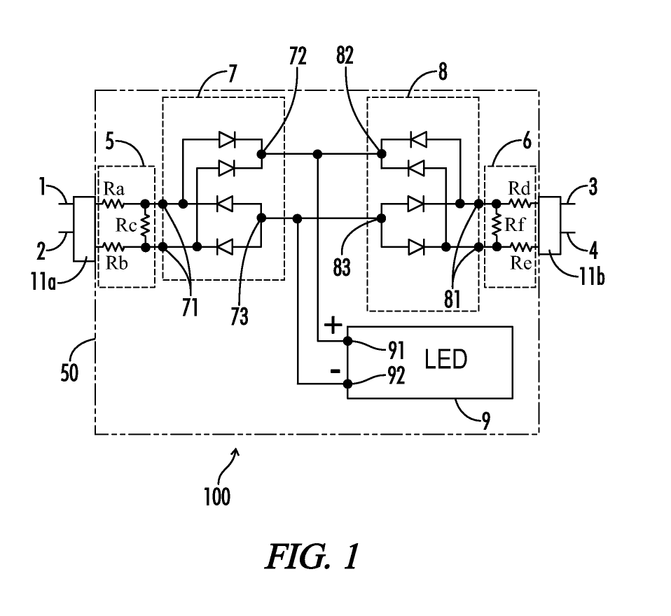

Referring to FIG. 1, in an embodiment an LED assembly 100 may include a lighting tube 50, bases 11a and 11b, resistive circuits 5 and 6, bridge rectifier circuits 7 and 8, and an LED unit 9.

The bases 11a and 11b may be arranged in both ends of the tube 50 with a shape to meet standards such as for example JIS (Japan Industrial Standards) for existing straight-tube fluorescent lamps. Each of the bases 11a and 11b as shown includes two power supply connectors (also known alternatively as base pins, power supply terminal wires, etc.) which may be made conductive with respect to an AC power source (not shown). As shown in FIG. 1, the base 11a has power supply connectors 1 and 2, while the base 11b has power supply connectors 3 and 4.

The resistive circuit 5 may be arranged on a printed substrate (not shown) in the tube 50, and an AC voltage is applied thereto via the power supply connectors 1 and 2 as shown in FIG. 1. Similarly, the resistive circuit 6 may be arranged on a printed substrate (not shown) in the tube 50, and an AC voltage is applied thereto via the power supply connectors 3 and 4 as shown in FIG. 1.

In embodiments as shown in FIG. 1, the resistive circuit 5 includes a resistor Ra, a resistor Rb and a resistor Rc, while the resistive circuit 6 includes a resistor Rd, a resistor Re and a resistor Rf. The resistor Ra is connected in series to the power supply connector 1, the resistor Rb is connected in series to the power supply connector 2 and the resistor Rc is connected in series to the resistor Ra and the resistor Rb while being connected to a side of the rectifier circuit 7.

The resistor Rd is connected in series to the power supply connector 3, the resistor Re is connected in series to the power supply connector 4, and the resistor Rf is connected in series to the resistor Rd and the resistor Re while being connected to a side of the rectifier circuit 8.

The rectifier circuit 7 may be arranged on a printed substrate (not shown) in the tube 50, and as shown in FIG. 1 includes a plurality of diodes effective to rectify an AC voltage output from the resistive circuit 5. Similarly, the rectifier circuit 8 may be arranged on a printed substrate (not shown) in the tube 50, and as shown in FIG. 1 includes a plurality of diodes effective to rectify an AC voltage output from the resistive circuit 6.

An AC voltage may be supplied from an AC power source (not shown) to the resistive circuit 5 via the power supply connector 1 and the power supply connector 2. The AC voltage is applied to terminals 71 of the rectifier circuit 7 via the resistive circuit 5. A cathode-side component (e.g., the cathode of one or more rectifier diodes) in rectifier circuit 7 is coupled to a positive input terminal 91 of the LED unit 9 via a terminal 72. An anode-side component (e.g. the anode of one or more rectifier diodes) in the rectifier circuit 7 is also coupled to a negative input terminal 92 of the LED unit 9 via a terminal 73.

Similarly, an AC voltage may be supplied from an AC power source (not shown) to the resistive circuit 6 via the power supply connector 3 and the power supply connector 4. The AC voltage is applied to terminals 81 of the rectifier circuit 8 via the resistive circuit 6. A cathode-side component in rectifier circuit 8 is coupled to the positive input terminal 91 of the LED unit 9 via a terminal 82. An anode-side component in rectifier circuit 8 is also coupled to the negative input terminal 92 of the LED unit 9 via a terminal 83.

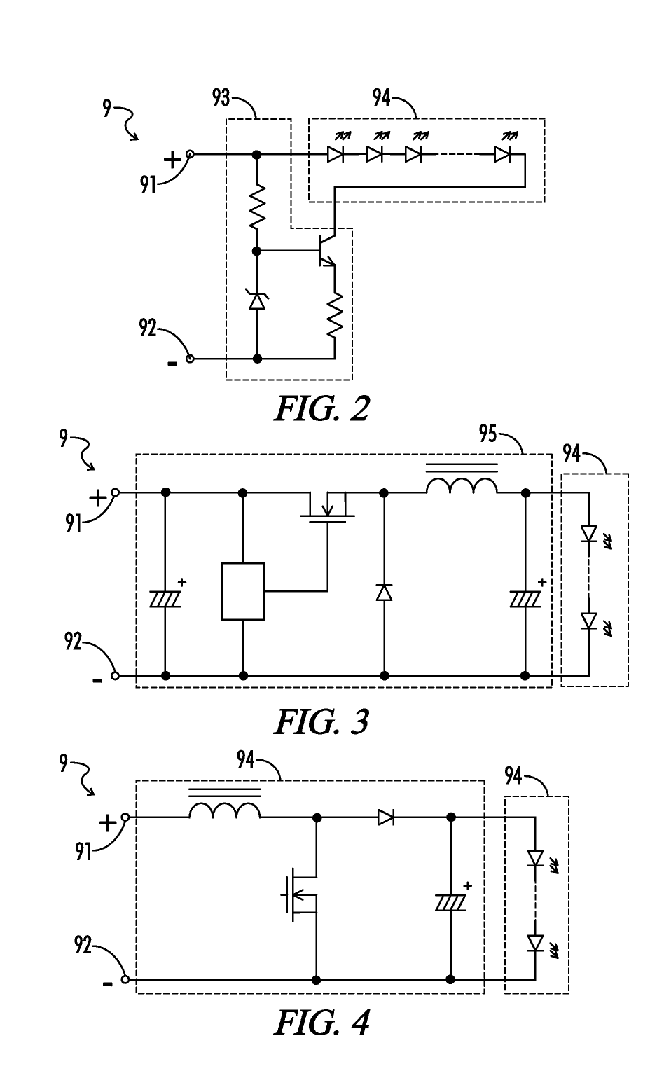

The LED unit 9 may be arranged on a printed substrate (not shown) in the tube 50, wherein a DC voltage rectified in the rectifier circuit 7 and the rectifier circuit 8 is received by the positive input terminal 91 and the negative input terminal 92, and the received DC voltage is used to turn on and further drive an LED element 94 provided internally therein. FIGS. 2 to 6 are circuit diagrams showing various embodiments of internal configurations for an LED unit 9 of the present invention, wherein the received DC voltage may be regulated by intermediate voltage regulating circuitry and then supplied to drive the LED elements 94.

An LED unit 9 as shown in FIG. 2 includes a dropper-type circuit 93 and a plurality of LED elements 94. The type of the LED elements 94 may be either a surface mounting LED element or a shell-type LED element.

An alternative embodiment of an LED unit 9 as shown in FIG. 3 includes a step-down chopper circuit 95 and a plurality of LED elements 94.

Another embodiment of an LED unit 9 as shown in FIG. 4 includes a step-up chopper circuit 96 and a plurality of LED elements 94. If the LED unit 9 embodiment as shown in FIG. 4 is used, distortion of a current input to the LED unit 9 can be suppressed.

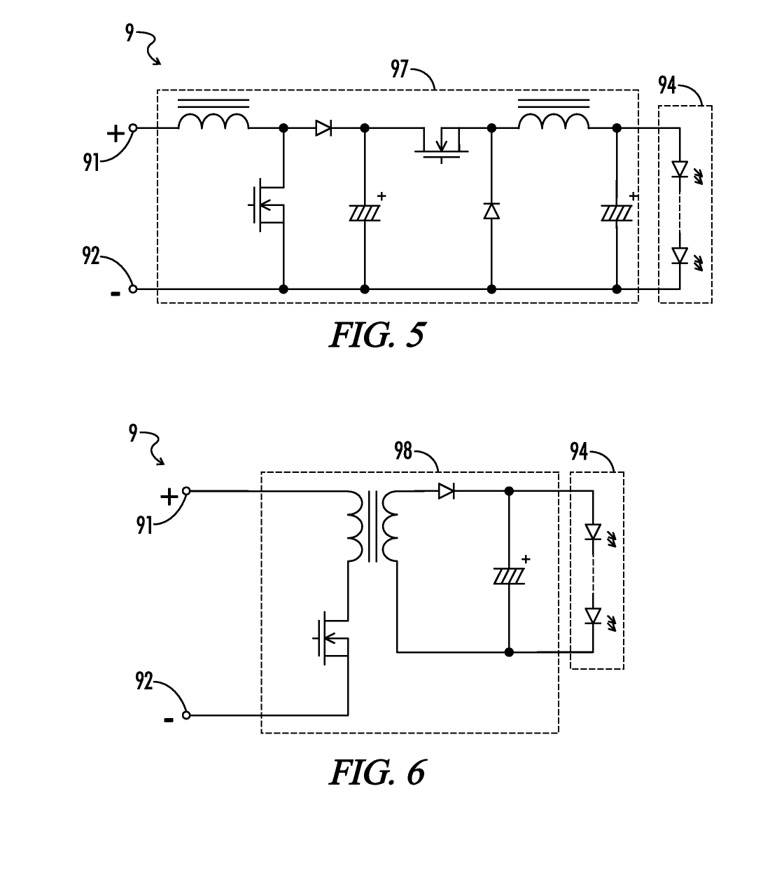

Another embodiment of an LED unit 9 as shown in FIG. 5 includes a step-up/step-down chopper circuit 97 which represents a combination of the step-down chopper circuit 95 shown in FIG. 3 and the step-up chopper circuit 96 shown in FIG. 4, and a plurality of LED elements 94. Similar to the step-down chopper circuit shown in FIG. 4, using the LED unit 9 shown in FIG. 5 makes it possible to reduce distortion of current input to the LED unit 9.

Another embodiment of an LED unit 9 as shown in FIG. 6 includes an isolated power supply circuit 98 having a flyback-type configuration and a plurality of LED elements 94. In addition, it is possible to apply a basic circuit of a DC power source to the LED unit 9, although it is not shown or otherwise described herein.

The LED unit 9 of the present invention is provided with a similar circuit configuration with regards to other embodiments to be described later, so further explanation of the LED unit 9 in these cases will be omitted as unnecessary.

Returning to an embodiment of the LED assembly 100 as shown in FIG. 1, the resistance of the resistors in the resistive circuit 5 (i.e. resistor Ra, resistor Rb and resistor Rc), the resistance of each of the resistors in the resistive circuit 6 (i.e. resistor Rd, resistor Re and resistor Rf), and combined impedance in the circuitry of the LED unit 9 are assumed to be set in advance so as to establish relationships (1) to (4) as described below. It may be assumed that the resistance of Ra is RA, the resistance of the resistor Rb is RB, the resistance of resistor Rc is RC, the resistance of resistor Rd is RD, the resistance of resistor Re is RE, the resistance of resistor Rf is RF, and the combined impedance in the circuits of the LED unit 9 is Z(LED).

(1) The resistance RA+RB+RC is assumed to be substantially equal to the resistance of a filament of a fluorescent lamp which is used in a general fluorescent lamp fixture. Note that RA+RB+RC indicates the impedance to be seen from the base 11a (or a side of the power supply connector 1 and the power supply connector 2 in FIG. 1).

(2) The resistance RA+RD+Z(LED) is assumed to be substantially equal to the impedance obtained in lighting (i.e., during a lighting operation or in other words while the filaments are “hot”) of a fluorescent lamp which is used in a general fluorescent lamp fixture.

(3) The resistance RB+RE+Z(LED) is assumed to be substantially equal to the impedance obtained in lighting of a fluorescent lamp which is used in a general fluorescent lamp fixture.

(4) The resistance RD+RE+RF is assumed to be substantially equal to the resistance of a filament of a fluorescent lamp which is used in a general fluorescent lamp fixture. Note that RD+RE+RF indicates an impedance to be seen from the base 11b (or a side of the power supply connector 3 and the power supply connector 4 in FIG. 1).

As described herein, the resistance of a fluorescent lamp filament in a fluorescent lamp which is used or otherwise is attachable to the existing general fluorescent lamp fixture (for example about a few thousand ohms), and an impedance obtained in lighting of the fluorescent lamp (for example about a few hundred ohms), may vary according to particular lamp characteristics but are well known to those of skill in the art in association with each of the various types of fluorescent lamps (i.e., T4, T5, T8, T12, etc.).

Explained next will be the operation of an embodiment of the LED assembly 100 of the present invention when mounted to a fluorescent lamp fixture of a rapid start system with a ballast mounted thereon, such as is shown in FIG. 12. When the LED assembly 100 is mounted on the fluorescent lamp fixture shown in FIG. 12, an AC voltage is supplied from an AC power source (not shown) either across power supply connector 1 and power supply connector 3 or across power supply connector 2 and power supply connector 4. At this time, a preheating voltage generated from the ballast (as shown by a dotted line in FIG. 12) is applied across power supply connector 1 and power supply connector 2 and also across power supply connector 3 and power supply connector 4.

When an AC voltage is applied across power supply connector 1 and power supply connector 3 and across power supply connector 2 and power supply connector 4, the AC voltage is applied to terminal 71 of the rectifier circuit 7 and terminal 81 of the rectifier circuit 8 via the resistive circuit 5 and the resistive circuit 6 respectively. The applied AC voltage is rectified by the rectifier circuit 7 and the rectifier circuit 8.

The rectifier circuit 7 outputs a cathode-side component of a DC voltage obtained after the rectification to terminal 72. At this time, a positive voltage exists on the positive input terminal 91 of the LED unit 9 which is connected to terminal 72. The rectifier circuit 7 also outputs an anode-side component of a DC voltage obtained after the rectification to terminal 73. At this time, a negative voltage (or zero potential) exists on the negative input terminal 92 of the LED unit 9 which is connected to terminal 73.

Similarly, the rectifier circuit 8 outputs a cathode-side component of a DC voltage obtained after the rectification to terminal 82. At this time, a positive voltage exists on the positive input terminal 91 of the LED unit 9 which is connected to terminal 82. The rectifier circuit 8 also outputs an anode-side component of a DC voltage obtained after the rectification to terminal 83. At this time, a negative voltage (or zero potential) exists on the negative input terminal 92 of the LED unit 9 which is connected to terminal 83.

For example, in an embodiment of the LED unit 9 which uses the dropper circuit as shown in FIG. 2, a DC voltage rectified by the rectifier circuit 7 and the rectifier circuit 8 is supplied across the positive terminal 91 and the negative terminal 92. The supplied DC voltage is used by the LED unit 9 to drive an LED element arranged in the LED unit 9. Even in the case of an LED unit 9 with circuitry as shown in any one or more of FIGS. 3 to 6, the operation regarding driving of the LED unit 9 is similar to that of the case shown in FIG. 2.

Moreover, a preheating voltage generated across power supply connector 1 and power supply connector 2 or across power supply connector 3 and power supply connector 4 is subjected to power consumption in each of the resistors in the resistive circuit 5 or the resistive circuit 6 (i.e. resistors Ra, Rb, Rc, Rd, Re and Rf), whereby there is no short-circuit in the power source.

As stated above, a DC voltage is supplied to the LED unit 9 by attaching the LED assembly 100 to the fluorescent lamp fixture of a rapid start type (with ballast mounted thereon) as shown in FIG. 12. As a result, lighting of the LED assembly 100 is realized. Furthermore, a preheating voltage generated across power supply connector 1 and power supply connector 2 or across power supply connector 3 and power supply connector 4 is also subjected to power consumption by the resistive circuit 5 or the resistive circuit 6, whereby there is no short-circuit in the power source.

Explained next will be circuit operation when an embodiment of an LED assembly 100 in accordance with the present invention is mounted on the conventional fluorescent lamp fixture of an inverter type with a ballast mounted thereon which is shown in FIG. 13. When the LED assembly 100 is mounted on the fluorescent lamp fixture shown in FIG. 13, a high frequency voltage is applied either across power supply connector 1 and power supply connector 3 or across power supply connector 2 and power supply connector 4. At this time, a preheating voltage generated from the inverter is applied across power supply connector 1 and power supply connector 2 and also across power supply connector 3 and power supply connector 4 into the resistive circuit 5 and the resistive circuit 6.

When a high frequency voltage is supplied across power supply connector 1 and power supply connector 3, and across power supply connector 2 and power supply connector 4, the high frequency voltage is applied to terminal 71 of the rectifier circuit 7 and terminal 81 of the rectifier circuit 8 via the resistive circuit 5 and the resistive circuit 6 respectively. The applied AC voltage is rectified by the rectifier circuit 7 and the rectifier circuit 8. Note that a rectifier (such as diode) used for the rectifier circuit 7 and the rectifier circuit 8 is desirably a rectifier of a type which is capable of corresponding to high frequencies.

The rectifier circuit 7 outputs a cathode-side component of a DC voltage obtained after the rectification to terminal 72. At this time, a positive voltage is present on the positive input terminal 91 of the LED unit 9 which is connected to terminal 72. The rectifier circuit 7 also outputs an anode-side component of a DC voltage obtained after the rectification to terminal 73. At this time, a negative voltage (or zero potential) is present on the negative input terminal 92 of the LED unit 9 which is connected to terminal 73.

Similarly, the rectifier circuit 8 outputs a cathode-side component of a DC voltage obtained after the rectification to terminal 82. At this time, a positive voltage is present on the positive input terminal 91 of the LED unit 9 which is connected to terminal 82. The rectifier circuit 8 also outputs an anode-side component of a DC voltage obtained after the rectification to terminal 83. At this time, a negative voltage (or zero potential) occurs in the negative input terminal 92 of the LED unit 9 which is connected to terminal 83.

For example, in an embodiment of the LED unit 9 which uses the dropper circuit as shown in FIG. 2, a DC voltage rectified by the rectifier circuit 7 and the rectifier circuit 8 is applied between the positive terminal 91 and the negative terminal 92. The applied DC voltage is used by the LED unit 9 to drive an LED element arranged in the LED unit 9. Even in the case of an LED unit 9 having circuitry as shown in any one or more of FIGS. 3 to 6, operation regarding lighting of the LED unit 9 is similar to that of the case shown in FIG. 2.

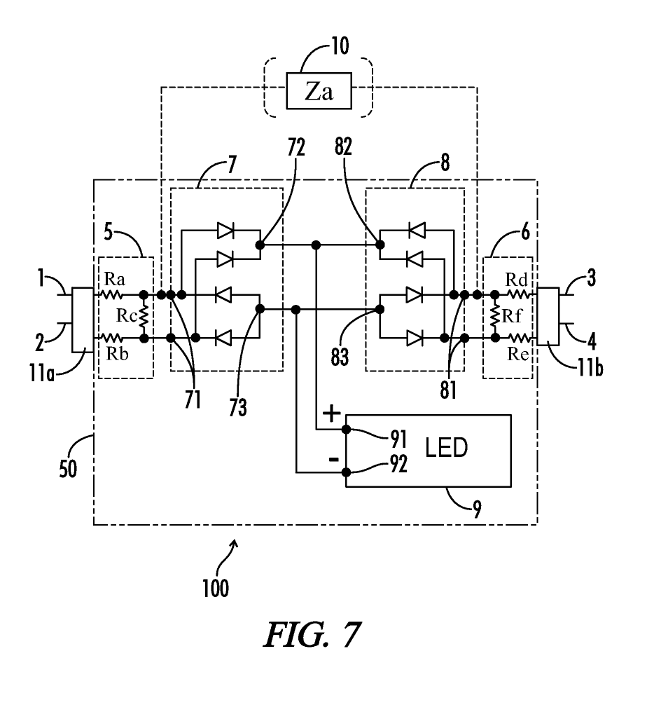

Furthermore, a preheating voltage generated across power supply connector 1 and power supply connector 2 or across power supply connector 3 and power supply connector 4 is subjected to power consumption in each of the resistors in the resistive circuit 5 or the resistive circuit 6 (i.e. resistors Ra, Rb, Rc, Rd, Re and Rf), whereby there is no short-circuit in the power source. Also, as shown in FIG. 7, in order to maintain an appropriate operation in the inverter shown in FIG. 13, an impedance circuit 10 (i.e. impedance Za in the impedance circuit 10) which was adjusted in advance may also be connected in parallel with rectifier circuits 7 and 8, as needed.

As stated above, a DC voltage is applied to the LED unit 9 by attaching the LED assembly 100 to a conventional fluorescent lamp fixture of an inverter type (with the ballast mounted thereon) as shown in FIG. 13. As a result, lighting of the LED assembly 100 is realized. Furthermore, a preheating voltage generated across power supply connector 1 and power supply connector 2 or across power supply connector 3 and power supply connector 4 is also subjected to power consumption by the resistive circuit 5 or the resistive circuit 6, whereby there is no short-circuit in the power source.

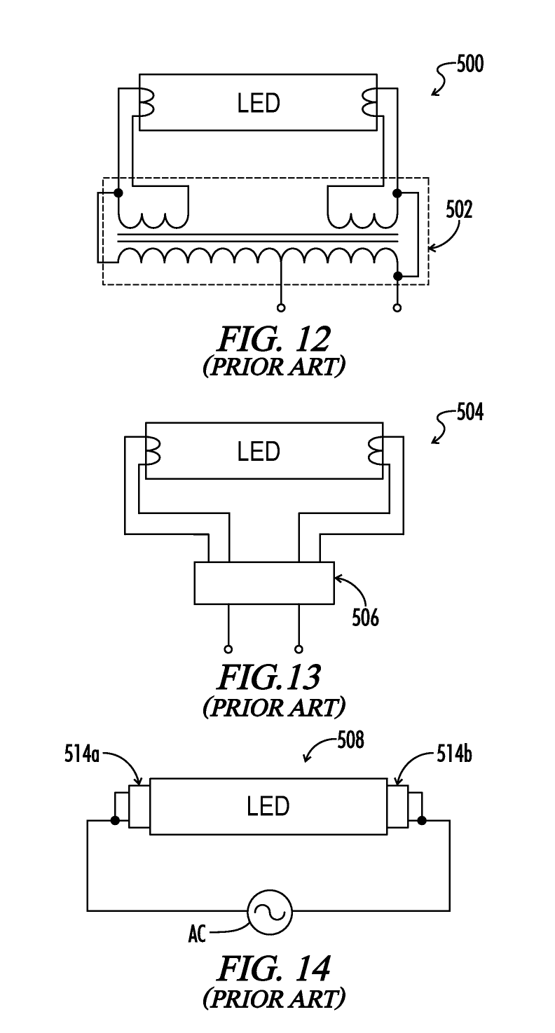

Explained next will be circuit operation when the LED assembly 100 is mounted on a conventional fluorescent lamp fixture of a glow starter type and with a ballast mounted thereon, as shown in FIG. 14. When the LED assembly 100 is mounted on the fluorescent lamp fixture shown in FIG. 14, an AC voltage is supplied from an AC power source (not shown) across power supply connector 1 and power supply connector 3, across power supply connector 1 and power supply connector 4, across power supply connector 2 and power supply connector 3, and/or across power supply connector 2 and power supply connector 4.

When an AC voltage is applied across power supply connector 1 and power supply connector 3, across power supply connector 1 and power supply connector 4, across power supply connector 2 and power supply connector 3, and across power supply connector 2 and power supply connector 4, the AC voltage is applied to terminal 71 of the rectifier circuit 7 and terminal 81 of the rectifier circuit 8 via the resistive circuit 5 and the resistive circuit 6 respectively. The applied AC voltage is rectified by the rectifier circuit 7 and the rectifier circuit 8.

The rectifier circuit 7 outputs a cathode-side component of a DC voltage obtained after the rectification to terminal 72. At this time, a positive voltage occurs in the positive input terminal 91 of the LED unit 9 which is connected to terminal 72. The rectifier circuit 7 also outputs an anode-side component of a DC voltage obtained after the rectification to terminal 73. At this time, a negative potential (or zero potential) occurs in the negative input terminal 92 of the LED unit 9 which is connected to terminal 73.

Similarly, the rectifier circuit 8 outputs a cathode-side component of a DC voltage obtained after the rectification to terminal 82. At this time, a positive voltage exists on the positive input terminal 91 of the LED unit 9 which is connected to terminal 82. The rectifier circuit 8 also outputs an anode-side component of a DC voltage obtained after the rectification to terminal 83. At this time, a negative voltage (or zero potential) occurs in the negative input terminal 92 of the LED unit 9 which is connected to terminal 83.

For example, in the case of an LED unit 9 which uses the dropper circuit as shown in FIG. 2, a DC voltage rectified by the rectifier circuit 7 and the rectifier circuit 8 is applied between positive terminal 91 and negative terminal 92. The applied DC voltage is used by the LED unit 9 to obtain lighting of an LED element arranged in the LED unit 9. In various embodiments of an LED unit 9 having circuitry as shown for example in FIGS. 3 to 6, operation regarding lighting of the LED unit 9 is similar to that of the case shown in FIG. 2.

As stated above, a DC voltage is applied to the LED unit 9 by attaching the LED assembly 100 to a conventional fluorescent lamp fixture of a glow starter type (with the ballast mounted thereon) shown in FIG. 14. As a result, lighting of the LED assembly 100 is realized. Note that it is possible at this time to reduce power losses attributable to wiring on the printed substrate, as a resistance value in each of the resistor Ra, the resistor Rb, the resistor Rd and the resistor Re is smaller, which is more efficient.

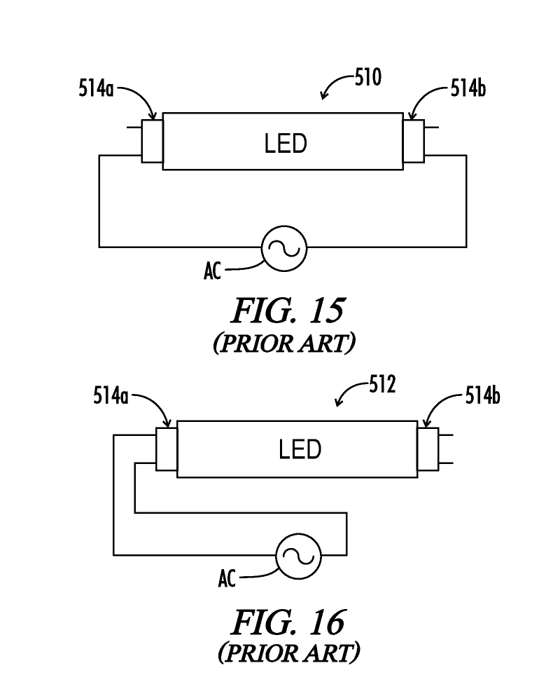

Explained next will be examples where an LED assembly 100 of the present invention is attached to fluorescent lamp fixtures with wiring configurations as shown in FIGS. 15 and 16. In this case, an embodiment of the LED assembly 100 as shown in FIG. 1 and previously described above makes it possible to realize lighting of the LED lamp 9 without causing a short-circuit in the power source. More specifically, if a wiring configuration is provided as shown in FIG. 15, an AC voltage supplied from an AC power source is applied across power supply connector 1 and power supply connector 3 or across power supply connector 2 and power supply connector 4, whereby the result will be similar to that of the above example wherein the LED assembly 100 is mounted on the fluorescent lamp fixture shown in FIG. 14.

In the case of a wiring configuration as shown in FIG. 16, an AC voltage supplied from an AC power source can be considered as being supplied across power supply connector 1 and power supply connector 2 or across power supply connector 3 and power supply connector 4. This case corresponds to the example of supplying an AC voltage from the base 11a (or the base 11b) on one side of the LED assembly 100 as described above. Since the LED assembly 100 in various embodiments has a symmetrical structure with regards to both sides of the base 11a and the base 11b, even with an AC power source supplied only from the base 11a (or base 11b) on one side, there is no short-circuit in the power source and lighting of the LED unit 9 is not affected.

As explained above, an embodiment of an LED assembly 100 of the present invention can be safely attached to existing fluorescent lighting fixtures. Furthermore, whether the fluorescent lamp fixtures use a ballast of a glow starter system, a ballast of a rapid-start system, or a ballast of an inverter system, and even with special wiring configurations between an AC power source and power supply connectors, it is possible to realize lighting of the LED unit without causing a short-circuit in the power source.

The load circuit in the tube 50 as previously described is not limited merely to the LED unit 9, but any devices/means which can be used based on a DC voltage obtained after rectification may also be a load. For example, the load may also be an LED illumination unit or sensor provided with a remote control light receiving module. In addition, the load may also have an AC/DC converter, and is further applicable to a speaker unit, heater, network wireless unit, exclusive power source output device or other devices.

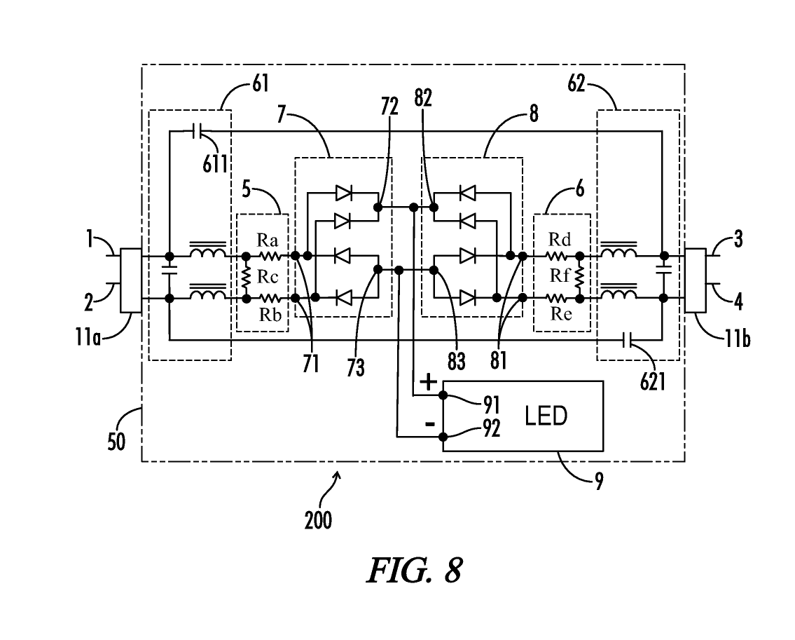

Referring now to FIG. 8, in an embodiment of the present invention an LED assembly 200 differs from an LED assembly 100 as shown in FIG. 1 in that a first power source noise filter 61 may be arranged between power supply connectors 1, 2 and the resistive circuit 5, and a second power source noise filter 62 may be arranged between power supply connectors 3, 4 and the resistive circuit 6 on for example a printed substrate (not shown) in the tube 50. Other than the noise filters 61, 62, the internal configuration and effects of respective parts in the internal configuration are similar to those of the assembly shown in FIG. 1, and further explanation of the contents thereof may be omitted as redundant. Note that FIG. 8 uses the same reference numbers for component elements which are commonly used in FIG. 1.

The power source noise filter 61 is provided to remove noise present in a waveform component of an AC voltage supplied from an AC power source (not shown) via the power supply connectors 1, 2. Similarly, the power source noise filter 62 is provided to remove noise present in a waveform component of an AC voltage supplied from an AC power source (not shown) via the power supply connectors 3, 4. As shown in FIG. 8, the power source noise filters 61, 62 are coupled via capacitors 611, 621 rather than serving as independent elements.

As shown in FIG. 8, resistor Ra is connected in series to the power supply connector 1, resistor Rb is connected in series to the power supply connector 2, and resistor Rc is connected in series to resistor Ra and resistor Rb while being connected to a side of the power source noise filter 61. Similarly, resistor Rd is connected in series to the power supply connector 3, resistor Re is connected in series to the power supply connector 4, and resistor Rf is connected in series to resistor Rd and resistor Re while being connected to a side of the power source noise filter 62.

An AC voltage is applied from an AC power source (not shown) to the power source noise filter 61 via the power supply connectors 1, 2. The power source noise filter 61 removes (filters) noise in the applied AC voltage so as to apply a filtered AC voltage to the resistive circuit 5. The AC voltage is applied to terminals 71 of the rectifier circuit 7 via the resistive circuit 5. A cathode-side component obtained by the rectifier circuit 7 is applied to the positive input terminal 91 of the LED unit 9 via terminal 72. An anode-side component obtained by the rectifier circuit 7 is also applied to the negative input terminal 92 of the LED unit 9 via terminal 73.

Similarly, an AC voltage is applied from an AC power source (not shown) to the power source noise filter 62 via the power supply connectors 3, 4. The power source noise filter 62 removes (filters) noise in the applied AC voltage so as to apply a filtered AC voltage to the resistive circuit 6. The AC voltage is applied to terminal 81 of the rectifier circuit 8 via the resistive circuit 6. A cathode-side component obtained by the rectifier circuit 8 is applied to the positive input terminal 91 of the LED unit 9 via terminal 82. An anode-side component obtained by the rectifier circuit 8 is also applied to the negative input terminal 92 of the LED unit 9 via terminal 83.

In an embodiment so configured, the resistance of each of the resistors in the resistive circuit 5 (i.e., resistor Ra, resistor Rb and resistor Rc), the resistance of each of the resistors in the resistive circuit 6 (i.e. resistor Rd, resistor Re and resistor Rf), and the combined impedance in the circuits of the LED unit 9 are assumed to be set in advance so as to establish the following relationships. It is assumed that the resistance of resistor Ra is RA, the resistance of resistor Rb is RB, the resistance of resistor Rc is RC, the resistance of resistor Rd is RD, the resistance of resistor Re is RE, the resistance of resistor Rf is RF, and the combined impedance in the circuits of the LED unit 9 is Z(LED).

(1) The resistance RA is assumed to be a value substantially equal to the resistance of a filament of a fluorescent lamp which may be used in a general fluorescent lamp fixture. Note that, since the resistor Rc is arranged on a side of the power source noise filter 61 in the second embodiment, the resistor Rc indicates an impedance to be seen from the base 11a (or a side of the power supply connectors 1, 2 in FIG. 8).

(2) The resistance RA+RD+Z(LED) is assumed to be substantially equal to the impedance obtained in lighting of a fluorescent lamp which may be used in a general fluorescent lamp fixture.

(3) The resistance RB+RE+Z(LED) is assumed to be substantially equal to the impedance obtained in lighting of a fluorescent lamp which may be used in a general fluorescent lamp fixture.

4) The resistance RF is assumed to be substantially equal to a resistance of a filament of a fluorescent lamp which may be used in a general fluorescent lamp fixture. Note that, since the resistor Rf is arranged on a side of the power source noise filter 62 in the second embodiment, the resistor Rf indicates an impedance to be seen from the base 11b (or a side of the power supply connectors 3, 4 in FIG. 8).

The LED assembly 200 of embodiments as described above makes it possible to remove noise in an AC voltage supplied from an AC power source by adding the power source noise filters 61, 62 to other embodiments of the LED assembly 100 which may be otherwise equivalent. An LED assembly 200 such as shown in FIG. 8 enables appropriate rectification by rectifier circuit 7 and rectifier circuit 8 based on an AC voltage obtained after noise filtering. Therefore, positive/negative voltages are appropriately supplied to the LED unit 9, whereby the LED unit 9 turns on and drives an LED element arranged in the LED unit 9.

Moreover, even with a wiring configuration as shown in FIG. 16, the LED assembly 200 makes it possible, owing to relationships of the resistor Ra, the resistor Rb, the resistor Rc, or the resistor Rd, the resistor Re, the resistor Rf on the circuit, and in comparison with embodiments such as shown in FIG. 1, to provide over-current protection by appropriately adjusting values in the resistor Rc or the resistor Rf, or via serial connection of a fuse or the like.

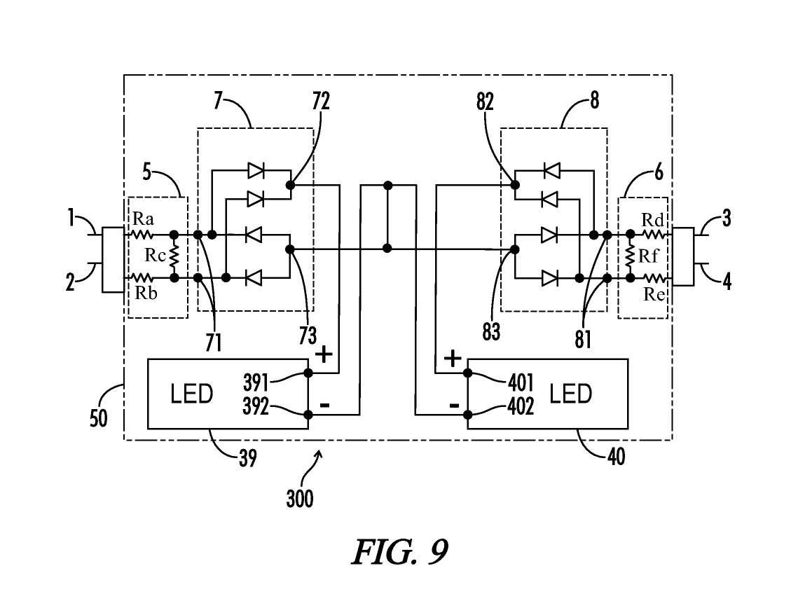

Referring now to FIG. 9, in an embodiment an LED assembly 300 differs from embodiments of the LED assembly 100 such as shown in FIG. 1, in that a DC voltage output from the rectifier circuit 7 is supplied to a first LED unit 39 and a DC voltage output from the rectifier circuit 8 is supplied to a second LED unit 40. Other than this aspect, the internal configuration and effects of respective parts in the configuration are similar to those of embodiments such as that shown in FIG. 1, so that further explanation of the contents thereof may be omitted as unnecessary. Note that FIG. 9 uses the same reference numbers for component elements which are commonly used in FIG. 1.

In embodiments as shown in FIG. 9, an LED assembly 300 includes a cathode-side component of a DC voltage rectified in the rectifier circuit 7 applied to a positive input terminal 391 of the LED unit 39 via terminal 72. An anode-side component of a DC voltage rectified in the rectifier circuit 7 is also applied to a negative input terminal 392 of the LED unit 39 via terminal 73.

Meanwhile, a cathode-side component of a DC voltage rectified in the rectifier circuit 8 is applied to a positive input terminal 401 of the LED unit 40 via terminal 82. An anode-side component of a DC voltage rectified in the rectifier circuit 8 is also applied to a negative input terminal 402 of the LED unit 40 via terminal 83.

In such an embodiment, the resistance of each of the resistors in the resistive circuit 5 (i.e. resistor Ra, resistor Rb and resistor Rc), the resistance of each of the resistors in the resistive circuit 6 (i.e. resistor Rd, resistor Re and resistor Rf), and the combined impedance in circuits of the LED units 39 and 40 are assumed to be set in advance so as to establish the following relationships. It is further assumed that the resistance of resistor Ra is RA, the resistance of resistor Rb is RB, the resistance of resistor Rc is RC, the resistance of resistor Rd is RD, the resistance of resistor Re is RE, the resistance of resistor Rf is RF, the combined impedance in the circuits of the LED unit 39 is Z(LED39), and the combined impedance in the circuits of the LED unit 40 is Z(LED40).

(1) The resistance RA+RB+RC is assumed to be substantially equal to the resistance of a filament of a fluorescent lamp which may be used in a general fluorescent lamp fixture. Note that RA+RB+RC indicates an impedance to be seen from the base 11a (or a side of the power supply connector 1 and the power supply connector 2 in FIG. 1).

(2) The resistance RA+RD+Z(LED39)+Z(LED40) is assumed to be substantially equal to impedance obtained in lighting of a fluorescent lamp which may be used in a general fluorescent lamp fixture.

(3) The resistance RB+RE+Z(LED39)+Z(LED40) is assumed to be substantially equal to the impedance obtained in lighting of a fluorescent lamp which may be used in a general fluorescent lamp fixture.

(4) The resistance RD+RE+RF is assumed to be substantially equal to the resistance of a filament of a fluorescent lamp which may be used in a general fluorescent lamp fixture. Note that RD+RE+RF indicates an impedance to be seen from the base 11b (or a side of the power supply connector 3 and the power supply connector 4 in FIG. 1).

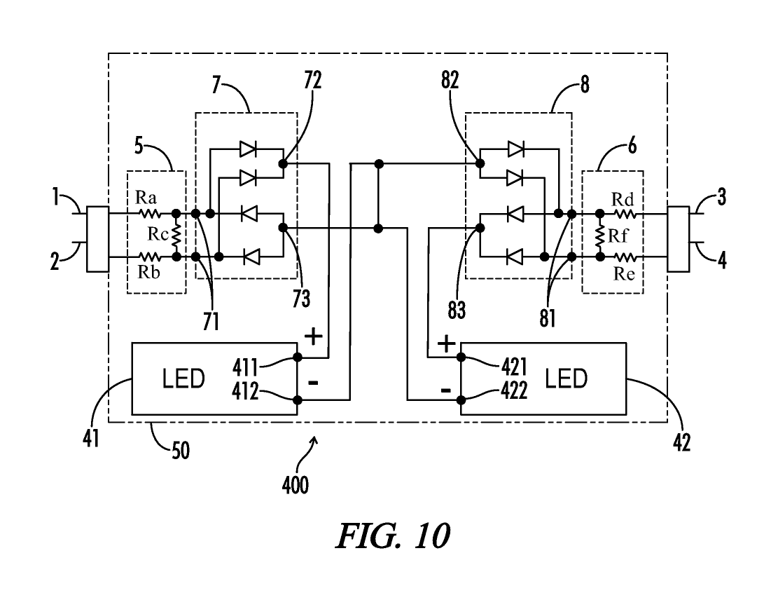

The LED assembly 300 in an embodiment as shown in FIG. 9 is operated basically in the same manner with the LED assembly 100 of FIG. 1 and as described above, and exhibits similar effects. In addition, the LED assembly 300 as shown in FIG. 9 further exhibits an effect such that a period of time to apply a DC voltage to the LED unit 39 and a period of time to apply a DC voltage to the LED unit 40 are alternated every half wave in one cycle of a waveform component of an AC voltage applied from an AC power source (not shown). Note that the circuit diagram of the LED assembly 300 of FIG. 9 may also be provided with equivalent wiring configurations to those of an embodiment of an LED assembly 400 such as shown in FIG. 10. At this time, the relationships among resistances value in each of the resistors in the resistive circuit 5 (i.e. resistor Ra, resistor Rb and resistor Rc), the resistance of each of the resistors in the resistive circuit 6 (i.e. resistor Rd, resistor Re and resistor Rf), and the combined impedance in the circuits of the LED units 39 and 40 are similar to those of the circuit shown in FIG. 9.

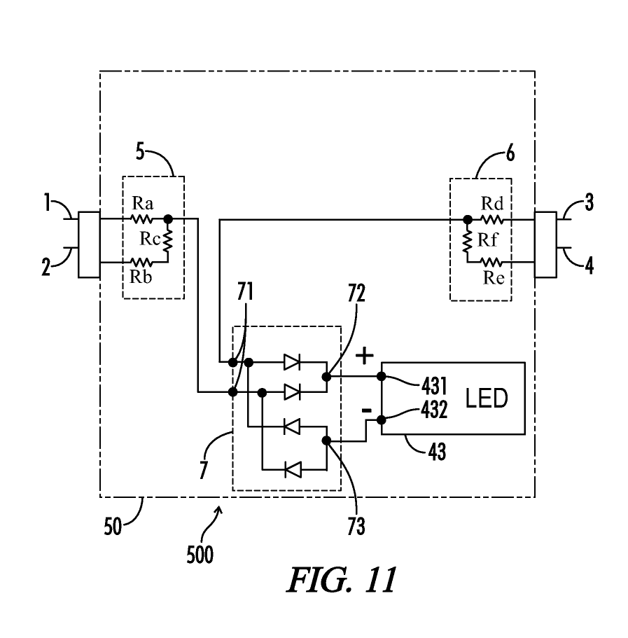

Referring now to FIG. 11, in an embodiment of the present invention an LED assembly 500 differs from an embodiment of the LED assembly 100 such as shown in FIG. 1 in that the LED assembly 500 of FIG. 11 has only one rectifier circuit 7.

More specifically, on a printed substrate (not shown) in the tube 50 shown in FIG. 11, the resistive circuit 5 is connected to one of terminals 71 in the rectifier circuit 7 and the resistive circuit 6 is connected to the other terminal 71 in the rectifier circuit 7.

Terminal 72 in the rectifier circuit 7 is connected to a positive input terminal 431 of an LED unit 43 and terminal 73 in the rectifier circuit 7 is connected to a negative input terminal 432 of the LED unit.

The resistance of each of the resistors in the resistive circuit 5 (i.e. resistor Ra, resistor Rb and resistor Rc), the resistance of each of the resistors in the resistive circuit 6 (i.e. resistor Rd, resistor Re and resistor Rf), and the combined impedance in circuits of the LED unit 43 are assumed to be set in advance so as to establish the following relationships. It is further assumed that the resistance of resistor Ra is RA, the resistance of resistor Rb is RB, the resistance of resistor Rc is RC, the resistance of resistor Rd is RD, the resistance of resistor Re is RE, the resistance of resistor Rf is RF, and the combined impedance in the circuits of the LED unit 43 is Z(LED43).

(1) The resistance RA+RB+RC is assumed to be substantially equal to the resistance of a filament of a fluorescent lamp which may be used in a general fluorescent lamp fixture. Note that RA+RB+RC indicates an impedance to be seen from the base 11a (or a side of the power supply connector 1 and the power supply connector 2 in FIG. 1).

(2) The resistance RA+RD+Z(LED43) is assumed to be substantially equal to the impedance obtained in lighting of a fluorescent lamp which may be used in a general fluorescent lamp fixture.

(3) The resistance RB+RE+Z(LED43) is assumed to be substantially equal to the impedance obtained in lighting of a fluorescent lamp which may be used in a general fluorescent lamp fixture.

(4) The resistance RD+RE+RF is assumed to be substantially equal to the resistance of a filament of a fluorescent lamp which may be used in a general fluorescent lamp fixture. Note that RD+RE+RF indicates an impedance seen from the base 11b (or a side of the power supply connector 3 and the power supply connector 4 in FIG. 1).

In the embodiments as shown in FIG. 11, the LED assembly 500 is operated in a substantially similar manner as that of an embodiment as shown in FIG. 1, and exhibits similar effects. However, the rectifier circuit for rectifying an AC voltage may be made of a single rectifier circuit 7 whereby reduced manufacturing costs can be realized in comparison with for example the LED assembly 100 as shown in FIG. 1.

Although various embodiments were explained above with reference to the accompanying drawings, an LED assembly according to the present invention is, needless to say, not limited to the above examples. It is obvious that those who are skilled in the art can achieve different kinds of modified examples and amended examples in a range disclosed in the scope of claims for patent. For example, the power source noise filters 61 and 62 shown in FIG. 8 may also be arranged in the LED assemblies 300, 400, 500 as shown in FIGS. 9 to 11 respectively.

Thus, although there have been described particular embodiments of the present invention of a new and useful LED Assembly and Circuit for Use in Fluorescent Lamp Fixtures, it is not intended that such references be construed as limitations upon the scope of this invention except as set forth in the following claims.

What is claimed is:

1. An LED assembly for use with an AC voltage applied from a fluorescent lamp fixture via one or more power supply connectors belonging to a base attachable to the fluorescent lamp fixture, the LED assembly comprising:
a resistive circuit having an impedance equivalent to that of a filament of a fluorescent lamp attachable to the fluorescent lamp fixture;
a rectifier circuit coupled to the resistive circuit and functional to rectify an AC voltage supplied via the resistive circuit; and
a load circuit coupled to the rectifier circuit, the load circuit operable in response to the rectified voltage.

2. The LED assembly of claim 1, wherein a combined impedance in the resistive circuit and the load circuit is equivalent to an impedance obtained in lighting of a fluorescent lamp.

3. The LED assembly of claim 2, further comprising a filter circuit coupled to the resistive circuit and functional to remove noise in an AC voltage supplied from the lamp fixture.

4. The LED assembly of claim 3, further comprising:
first and second bases arranged on first and second sides of the LED assembly, respectively;
the resistive circuit comprises first and second resistive circuits;
the filter circuit further comprises
a first filter arranged between the first resistive circuit for receiving application of the AC voltage and the first base; and
a second filter circuit arranged between the second resistive circuit for receiving application of the AC voltage and the second base.

5. The LED assembly of claim 4, wherein the load circuit further comprises an AC/DC converter.

6. The LED assembly of claim 5, wherein the load circuit further comprises a distortion suppressing circuit for suppressing distortion of a current input from the rectifier circuit.

7. The LED assembly of claim 6, wherein the load circuit is a light source.

8. The LED assembly of claim 7, wherein the load circuit is an LED unit.

9. The LED assembly of claim 6, wherein the load circuit is a sensor.

10. An LED assembly comprising:
a base adapted for attachment to a fluorescent lamp fixture and effective to receive an AC voltage from the fluorescent lamp fixture via one or more power supply connectors;
a resistive circuit coupled to the base and comprising one or more resistors having a first resistance value equivalent to that of a filament of a fluorescent lamp attachable to the fluorescent lamp fixture;
a rectifier circuit arranged to receive AC voltage from the resistive circuit and rectify the received AC voltage; and
an LED unit further comprising a voltage regulating circuit and one or more LED elements to be operated in response to the rectified voltage,
wherein a second impedance associated with a combination of one or more resistors of the resistive circuit and of the LED unit is equivalent to that of operating impedance for a fluorescent lamp attachable to the fluorescent lamp fixture.

11. The LED assembly of claim 10, wherein the voltage regulating circuit of the LED unit further comprises a dropper-type circuit.

12. The LED assembly of claim 10, wherein the voltage regulating circuit of the LED unit further comprises a step-down chopper circuit.

13. The LED assembly of claim 10, wherein the voltage regulating circuit of the LED unit further comprises a step-up chopper circuit.

14. The LED assembly of claim 10, wherein the voltage regulating circuit of the LED unit further comprises an isolated power supply circuit having a flyback configuration.

15. The LED assembly of claim 10, the base, resistive circuit and rectifier circuit further comprising a first base, first resistive circuit and first rectifier circuit, respectively, the LED assembly further comprising:
a second base opposing the first base;
a second resistive circuit coupled to the second base and having impedance equivalent to that of the first resistive circuit; and
a second rectifier circuit arranged to receive AC voltage from the second resistive circuit and rectify the received AC voltage.

16. The LED assembly of claim 15, further comprising an impedance circuit coupled across the first and second rectifier circuits.

17. The LED assembly of claim 15, further comprising a first filter circuit coupled between the first base and the first resistive circuit and a second filter circuit coupled between the second base and the second resistive circuit.

18. The LED assembly of claim 15, the LED unit comprising a first LED unit and a second LED unit, and
wherein a combined impedance value for each of a resistor associated with the first resistive circuit, a resistor associated with the second resistive circuit, an impedance for the first LED unit and an impedance for the second LED unit is equivalent to that of operating impedance for a fluorescent lamp attachable to the fluorescent lamp fixture.

19. An LED assembly comprising:
first and second opposing bases adapted for attachment to a fluorescent lamp fixture and effective to receive AC voltage from the fluorescent lamp fixture via one or more power supply connectors associated with each base;
first and second resistive circuits coupled to the first and second bases, respectively, and comprising one or more resistors having a first resistance value equivalent to that of a filament of a fluorescent lamp attachable to the fluorescent lamp fixture;
a rectifier circuit arranged to receive AC voltage from the first and second resistive circuits and rectify the received AC voltage; and
an LED unit further comprising a voltage regulating circuit and one or more LED elements to be operated in response to the rectified voltage,
wherein a second impedance associated with a combination of one or more resistors of the first resistive circuit, one or more resistors of the second resistive circuit, and of the LED unit is equivalent to that of operating impedance for a fluorescent lamp attachable to the fluorescent lamp fixture.

20. The LED assembly of claim 19, further comprising a first filter circuit coupled between the first base and the first resistive circuit and a second filter circuit coupled between the second base and the second resistive circuit.
